(19) United States
(12) Patent Application Publication
(10) Pub. No.: US 2007/0267884 A1
(43) Pub. Date: Nov. 22, 2007

(54) GRAB HANDLE SYSTEMS FOR A VEHICLE

(75) Inventors: David M. Failla, Lake Orion, MI (US); Steven J. Gage, Utica, MI (US); John L. Adams, Warren, MI (US); Herbert O. Stables, North Branch, MI (US); Kenneth D. Gmoser, Grosse Ile, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 11/419,627

(22) Filed: May 22, 2006

(51) Int. Cl. B60J 9/00

(52) U.S. Cl. 296/1.02

(57) ABSTRACT

A grab handle assembly (10) includes a grab handle (12) that is configured for vehicle occupant gripping and a single bracket (14). The grab handle (12) has a first set of attachment points (110). The bracket (14) has a second set of attachment points (114), which are configured to mechanically couple to the first set of attachment points (110). A first set of fasteners (19) is configured to attach the bracket (14) to the grab handle (12). A second set of fasteners (30) is configured to attach the bracket (14) to a vehicle structural member (28).

### TECHNICAL FIELD

The present invention relates to vehicle interior systems and components. More particularly, the present invention is related to the construction and components of vehicle interior grab handles and the incorporation thereof in a vehicle interior.

### BACKGROUND OF THE INVENTION

Grab handles are often provided in vehicles, such as automobiles and sport utility vehicles. The grab handles assist occupants as they enter and exit the vehicles, in adjusting and maintaining their seated positions, or in performing other similar or related tasks. A wide variety of grab handle designs are available. Grab handles are often attached to the vehicle roof or to one of the roof support pillars, commonly referred to as the A, B, or C pillars. As a few examples, the grab handles may be attached through a headliner to a vehicle structural member on a vehicle roof, to a trim piece, or through a trim piece to a vehicle structural member on a vehicle side. A vehicle structural member refers to a member that is part of the vehicle support structure or “body-in-white”, such as a frame, a sheet metal section, or the like. Grab handles are typically located near door openings, but may be located elsewhere in a vehicle.

A grab handle assembly typically includes a handle and multiple backing members, brackets, or the like. A first bracket is typically attached to the handle, which is then attached to a headliner or trim panel via a second bracket. The second bracket is then attached to a third bracket or directly to a vehicle structural member. For strength, one or more of the brackets is formed of a metal, such as steel, which has considerable associated weight. When a third bracket is used, the third bracket is typically fastened to the vehicle structural member. When the second bracket is directly attached to the vehicle structural member, a retaining stem and an anti-rotation stem on the second bracket are typically inserted into holes in the vehicle structure member. The retaining stem has a retaining tab, which prevents separation between the second bracket and the vehicle structural member. As another example, the second bracket may be directly attached to the vehicle structural member via a clip. The clip is attached to the second bracket and inserted into the vehicle structural member.

There is a desire to reduce the number, weight, and complexity of grab handle assembly components while at the same time provide the same or improved pull strength. In addition, it is further desired that the components of the grab handle assembly be airbag friendly, or in other words, configured not to damage an airbag during deployment thereof or to hinder such deployment. Furthermore, the grab handle assembly ought to handle industry environmental requirements, be quick and easy to install, have minimal associated manufacturing and installation costs, meet current impact safety requirements, and be made of materials that can be recycled. Moreover, the grab handle of the grab handle assembly ought to be aesthetically pleasing and comfortable to hold.

Thus, there exists a need for an improved grab handle assembly that satisfies the above-stated features and characteristics and that overcomes the disadvantages associated with conventional grab handle assemblies.

### SUMMARY OF THE INVENTION

The embodiments of the present invention provide several advantages. In one embodiment of the present invention, a grab handle assembly is provided that includes a grab handle and a single unitary bracket. The grab handle is configured for vehicle occupant gripping. The grab handle has a first set of attachment points. The bracket has a second set of attachment points, which are configured to mechanically couple to the first set of attachment points. A first set of fasteners is configured to attach the bracket to the grab handle. A second set of fasteners is configured to attach the bracket to a vehicle structural member. In another embodiment a method of manufacturing and assembling the same is also provided.

One advantage provided by an embodiment of the present invention is the incorporation of a single integrated unitary grab handle bracket that may be attached to a vehicle structural member and used solely to support a grab handle. The bracket reduces the number of components and complexity of a grab handle assembly.

Another advantage provided by another embodiment of the present invention is the incorporation of a single unitary bracket for a grab handle assembly that is formed of a lightweight thermoplastic material, which is configured and formed to meet required pull strength requirements.

Yet another advantage provided by another embodiment of the present invention is a grab handle assembly that meets environmental temperature operating and impact safety requirements.

Still another advantage provided by another embodiment of the present invention is the incorporation of a single unitary bracket for a grab handle assembly that is configured to be airbag friendly.

As well, another advantage provided by another embodiment of the present invention is a grab handle assembly that is formed of materials that can be recycled.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 is a perspective exploded view of a portion of a grab handle/article hook assembly in relation to a panel and illustrating grab handle attachment in accordance with an embodiment of the present invention;

FIG. 2 is a perspective exploded view of another portion of the grab handle assembly of FIG. 1 in relation to a panel and illustrating coat hook attachment;

FIG. 3 is a side perspective view of the grab handle assembly of FIG. 1 fully installed;

FIG. 4 is a back perspective view of a bracket of the grab handle assembly of FIG. 1;

FIG. 5 is a front perspective view of the bracket of FIG. 4;

FIG. 6 is a cross-sectional view through a fastener insert of the bracket of FIG. 4;

FIG. 7 is an exploded view of a grab handle assembly in accordance with another embodiment of the present invention;

FIG. 8 is a perspective view of a grab handle and a bracket of the grab handle assembly of FIG. 7;

FIG. 8A is a cross-sectional view through the grab handle and through a main section of the bracket of FIG. 8;

FIG. 9 is a back perspective view of the bracket of FIG. 8;

FIG. 10 is a perspective exploded view of a grab handle assembly in accordance with another embodiment of the present invention;

FIG. 11 is a front perspective view of a grab handle and a bracket of the grab handle assembly of FIG. 12;

FIG. 12 is a back perspective view of the bracket of FIG. 11;

FIG. 13 is a logic flow diagram illustrating a method of manufacturing and assembling a grab handle assembly in accordance with an embodiment of the present invention;

FIG. 14 is a perspective exploded view of an article hook assembly in relation to a panel and in accordance with another embodiment of the present invention;

FIG. 15 is a perspective exploded view of a grab handle assembly in relation to a panel utilizing similar components as that of the article hook assembly of FIG. 14 and is in accordance with another embodiment of the present invention;

FIG. 16 is a perspective exploded view of another grab handle assembly in relation to a panel that is configured for sunroof applications and is in accordance with another embodiment of the present invention; and

FIG. 17 is a logic flow diagram illustrating a method of manufacturing and assembling a grab handle assembly in accordance with another embodiment of the present invention.

### DETAILED DESCRIPTION

In each of the following figures, the same reference numerals are used to refer to the same components. While the present invention is described primarily with respect to overhead grab handle assemblies for a vehicle, the present invention may be adapted to various locations within a vehicle and to various vehicle applications. The present invention may be used in headliner applications, interior sidewall panel applications, console panel applications, rear trim panel applications, door panel applications, and other interior trim panel applications. The present invention may also be used on a vehicle roof, on a roof support pillar, on a door, on a dashboard, or elsewhere in a vehicle. The present invention may apply to automotive, aeronautical, nautical, and railway industries, as well as to other industries that utilize similar grab handles. Also, the present invention may be used to aid in the ingress and egress of a vehicle, may be used by a vehicle occupant for seated position adjustment or maintaining purposes, to close or open a door, for hanging cloths articles, as tie down anchors, or for other purposes and for performing various other tasks.

In the following description, various operating parameters and components are described for one constructed embodiment. These specific parameters and components are included as examples and are not meant to be limiting.

Also, in the following description the term “vehicle structural member”, in general, refers to a member that is part of the vehicle support structure or “body-in-white”, such as a frame, a sheet metal section, or the like. A vehicle structural member does not refer to an interior trim panel or the like. Although in multiple described embodiments of the present invention a vehicle structural member refers to a sheet metal section of a vehicle roof or roof support pillar, a vehicle structural member may be formed of materials other than metal. A vehicle structural member provides adequate support for a grab handle or, in other words, is capable of withstanding the pull forces commonly associated therewith.

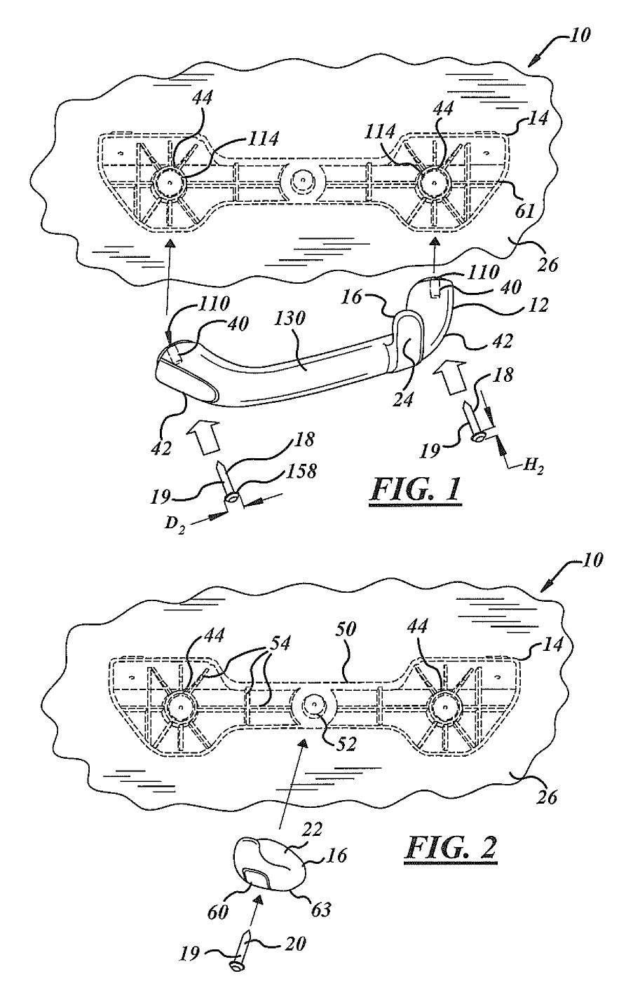

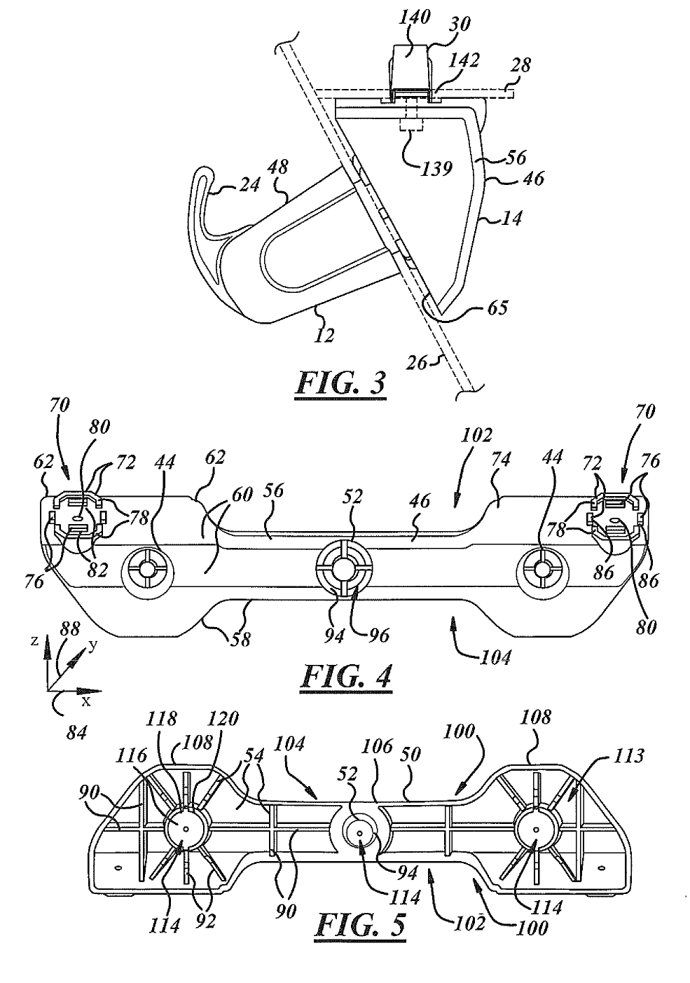

Referring now to FIGS. 1-3, perspective exploded views and a perspective side view of a grab handle/article hook assembly 10 in accordance with an embodiment of the present invention is shown. The grab handle assembly 10 includes a grab handle 12, a bracket 14, and one or more article hooks or coat hooks 16. The grab handle 12 is attached to the bracket 14 via a pair of fasteners 18 of a first set of fasteners 19. The first set of fasteners 19 also includes a third fastener 20, which may be used to attach a first coat hook 22 directly to the bracket 14. Each of the first set of fasteners 19 may be identical to and interchangeable with each other. A second coat hook 24 may be directly attached to the grab handle 12 and used in replacement of the first coat hook 22. However, since the first coat hook 22 is directly fastened to the bracket 14 and is more apt to be larger in size than the second coat hook 24, the first coat hook 22 is generally better able to hold or carry a heavier load. The handle 12 is attached to and is mounted on an opposite side of the trim panel 26 as the bracket 14. The first set of fasteners 19 prevents movement between the grab handle 12, the bracket 14, and the trim panel 26. The bracket 14 is coupled to a vehicle structural member 28 via a second set of fasteners 30 (only one is shown in FIG. 3).

The grab handle 12 may be a single unitary component that is configured for gripping by a vehicle occupant. The grab handle 12 may be right handed, left handed, or unhanded. The grab handle 12 may have a pair of passages 40 formed therein for placement of the pair of fasteners 18 therethrough. Fastener covers 42 may be used to cover the fasteners 18, as shown in FIGS. 1-2. The fastener covers 42 are formed of similar material and have similar exterior shape as the grab handle 12, such that when they are attached to the grab handle 12 they blend in and are virtually unnoticeable or, in other words, such that the fastener covers 42 and the grab handle 12 appear to be a single unit. As an alternative, the grab handle 12 may be attached to the bracket 14 by passage of the fasteners 18 through the appropriate outer fastener inserts 44 on the backside 46 of the bracket 14 and threaded into the grab handle 12. When the fasteners 18 are extended through the bracket 14 and into the grab handle 12, the grab handle 12 is a single unitary component without the fastener covers 42; the body 48 of the grab handle 12 is formed to assume the exterior surfaces of the fastener covers 42, as shown in FIG. 3.

The grab handle 12 may include the second coat hook 24 such that it is integrally formed as part of the grab handle 12, as shown, or may be attached to the grab handle 12. The grab handle 12 and the second coat hook 24 are shown as a single unitary component. The grab handle 12 may be a solid component or may have a hollow or semi-hollow interior.

Referring now also to FIGS. 4-5, back and front perspective views of the bracket 14 are shown. The bracket 14 is a single unitary component. The bracket 14 includes the outer shell 50, the outer inserts 44, the center fastener insert 52, and the internal ribs 54. The exterior backside surface 56 of the outer shell 50 is smooth and has rounded edges 58, transitions 60, and corners 62. The configuration of the exterior surface 56 makes the bracket 14 airbag friendly. The exterior surface 56 is void of any sharp edges or points upon which an airbag could get hung up or torn.

Although three fastener inserts are shown, any number may be utilized. The outer inserts 44 are associated with the grab handle 12 and the center insert 52 is associated with the first coat hook 22. The grab handle 12 attaches to the outer inserts 44. The first coat hook 22 may be attached to the center insert 52. Note that the grab handle 12, the bracket 14, and the first coat hook 22 as shown are designed such that only the grab handle 12 or the first coat hook 22 may be attached to the bracket 14 at any instance in time. The grab handle 12 and the first coat hook 22 may not be attached to the bracket simultaneously. Of course, the grab handle 12, the bracket 14, and/or the first coat hook 22 may be modified to allow for simultaneous attachment to the bracket 14.

The first coat hook 22 may be formed of similar materials as the grab handle 12. The first coat hook 22 may be fastened to the bracket 14 in a similar fashion as the grab handle 12. The first coat hook 22 may have a fastener cover 60 to cover the third fastener 20 that extends through the coat hook 22 and into the bracket 14, as shown. The fastener cover 60 is formed of similar material(s) and has similar exterior shape as the coat hook 22, such that when it is attached to the coat hook 22 it blends in and is virtually unnoticeable. As an alternative, the coat hook 22 may be attached to the bracket 14 by passage of the third fastener 20 through the center insert 52 from the backside 46 and threaded into the coat hook 22. When the third fastener 20 is extended through the bracket 46 and into the coat hook 22, the coat hook 22 is a single unitary component without the fastener cover 60; the body 63 of the coat hook 22 is formed to assume the exterior surface of the fastener cover 60.

The bracket 14 has a body 61 with an attachment side 65 and a support or topside 74. The bracket 14 also includes a pair of fastener hanging portions 70 with spacers 72 that are located on the topside 74 of the bracket 14. The spacers 72 include fastener mounting spacers 76 and vehicle structural member spacers 78. The spacers 72 protrude from and are integrally formed as part of the bracket 14. The spacers 72 have approximately the same height. The fastener spacers 76 are positioned on the bracket 14 about fastener attachment holes 80. The second set of fasteners 30 are oriented on the fastener mounting spacers 76 and are attached to the bracket 14 through the attachment holes 80. Each attachment hole 80 has two pairs of fastener spacers 76 associated therewith. In the example embodiment shown, first pairs of fastener spacers 82 are positioned in line with the attachment hole 80, across from each other, and parallel to the x-axis 84. The second pairs of fastener spacers 86 are positioned in line with the attachment holes 80, across from each other, and parallel to the y-axis 88. Note that the x-axis 84 and the y-axis 88 shown and stated herein refer to longitudinal and lateral directions across the bracket 14. For ease of assembly the x-axis 84 and the y-axis 88 may be in-line with the x-axis and y-axis of a vehicle. The vehicle structural member spacers 78 provide a tight stable arrangement between the bracket 14 and the vehicle structural member 28. The above-described spacer arrangement is one example configuration; other configurations may be utilized and are not outside the scope of the present invention.

The shape and position of the fastener mounting spacers 82 allows for the proper alignment and attachment of the second set of fasteners 30. The stated shape and position also allow the second set of fasteners 30 to be attached to the bracket 14 in multiple positions and to be aligned with the x-axis 84 or the y-axis 88. In another example embodiment, the fastener mounting spacers 82 are replaced with slots (not shown) in the bracket 14. The slots are in the same position as the fastener mounting brackets 82, but allow for the second set of fasteners 30 to clip therein. This arrangement aids in preventing the second set of fasteners 30 from rotating relative to the bracket 14.

The ribs 54 provide strength and rigidity. The layout of the ribs 54 is such to distribute the forces exerted on the grab handle 12. The ribs 54, as well as the shell 50, allow the bracket 14 to alone provide structural integrity to support and withstand forces exerted on an article hook and/or a grab handle. The forces are uniformly and quickly distributed across the grab handle 12. This allows for the bracket 14 to be formed of lightweight material(s). The ribs 54 include axis-oriented ribs 90 and fastener insert reinforcing ribs 92. The axis-oriented ribs 90 generally extend parallel to the x-axis 84 or the y-axis 88. The insert reinforcing ribs 92 extend radially outward from the outer inserts 44 and attach to the outer shell 50. Additional fastener insert reinforcing ribs may be incorporated and extend outward from the center insert 52, however, in the embodiment shown, the walls 94 of the center insert 52 are thickened. The thick walls 94 provide a solid reinforced cylindrical structure surrounding the center insert cavity 96. In one embodiment of the present invention, the ribs 54 are thinner than the outer shell 50. In another embodiment, the ribs 54 have a thickness of approximately 0.8-1.5 mm and the outer shell 50 has a thickness of approximately 1.5 mm-3.0 mm. The ribs 54 and the outer shell 50 may have predetermined uniform thicknesses.

The bracket 14 may have one or more cutouts 100 to allow for the placement of modules (not shown). For example, the bracket 14 shown has a top center cutout 102 and a bottom center cutout 104. The top center cutout 102 exists over a center arm 106 between two main outer sections 108. In the top center cutout 102 a vehicle module may be disposed between the main sections 108 and between the bracket 14 and the vehicle structural member 28. Of course, other modules, cables, channels, structures, or the like may be located within or extend through the cutouts 100. The cutouts 100 also reduce the size and/or weight of the bracket 14.

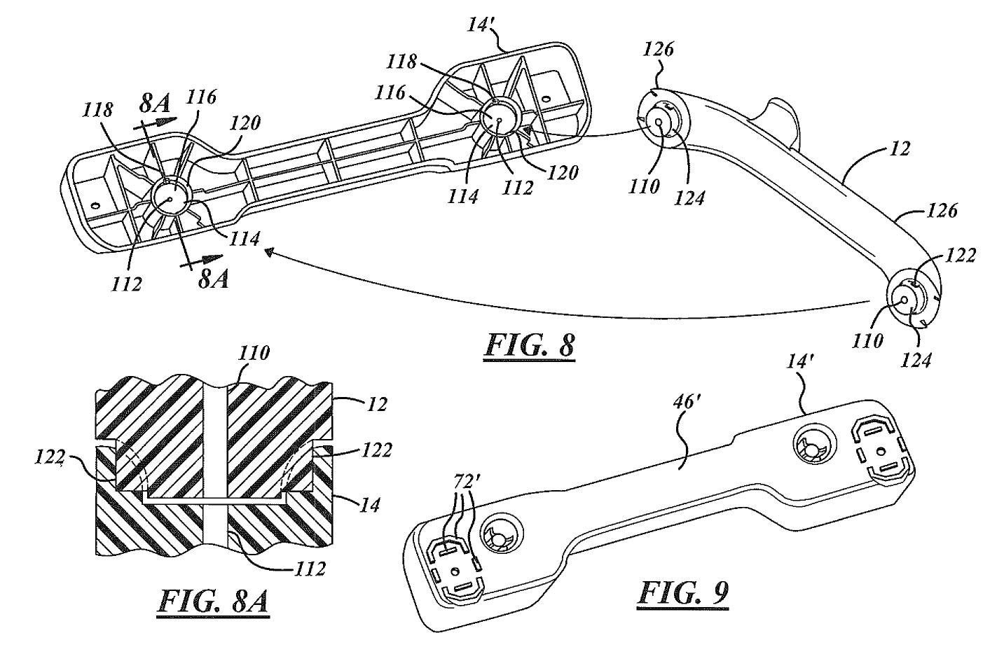

Referring now also to FIGS. 8 and 8A, the grab handle 12 has a first set of attachment points 110 and the bracket 14 has a corresponding second set of attachment points 112 in grab handle attachment areas 113. The second set of attachment points 112 are at the front ends 114 of the outer inserts 44 and are keyed. The front ends 114 have recessed circular middle sections 116 with notches 118 in the outer rims 120. The first set of attachment points 110 have tabs 122 that are located on cylindrically-shaped protruding portions 124 at the ends 126 of the grab handles 12. The protruding portions 124 and the tabs 122 are inserted into the recessed middle sections 116 and notches 118, respectively, and assure proper alignment and fitting between the grab handle 12 and the bracket 14. The grab handle 14 has a gripping location 130 that may have a rough or granular texture due to, for example, a stipple grain pattern or surface, for improved occupant gripping.

The grab handle 12 and the bracket 14 may be formed of various materials, such as polypropolyne, polypropylene, acrylonitrile butadiene styrene (ABS), acetal, polycarbonate, polycarbonate-ABS, magnesium silicate hydroxide (Talc), fiberglass, maleic anhydride-styrene polymer, styrene-butadiene polymer, a fiber reinforced thermoplastic, or other similar material known in the art or a combination thereof. In one example embodiment of the present invention, the bracket 14 is formed of a hardened material of approximately 30% glass filled polypropolyne or between 28%-32% glass filled polypropolyne. The 30% glass filled polypropolyne material provides substantial strength and is capable of holding up in extreme temperatures including within the temperature range of 40° C.-90° C. The grab handle 12 is generally formed of a softer material than the bracket 14 to provide improved gripping feel to a vehicle occupant. The softer material also provides improved energy absorbance or impact response and thus prevents occupant injury when coming in contact with the grab handle 12 during a collision event. The material of the grab handle 12 has a low gloss level. The angular reflectivity of light of the finished and cured grab handle 12 is such that it minimizes reflections seen by vehicle occupants. As an example, the gloss level may be approximately 2.0 or less to minimize reflective distractions and interference with a driver or occupant field-of-view.

The second set of fasteners 30 may be in the form of clips, as shown. The clips are held onto the bracket 14 via a third set of fasteners 139, which may be similar or identical the first set of fasteners. Each of the second set of fasteners 30 includes a pair of depression tabs 140 (only one is shown in FIG. 3), which are pinched prior to or during insertion into a panel hole 142 in the vehicle structural member 28. The tabs 140 extend outward upon being fully inserted into and through the panel hole 142 and prevent the bracket 14 from separating from the vehicle structural member 28. The second set of fasteners 30 may be designed to have a certain associated minimum press-in force. For example, in one embodiment, the second set of fasteners 30 are designed such that 16 lbs of force is applied to the bracket 14 near the fasteners 30 to depress and insert the tabs 140 into the vehicle structural member 28. The second set of fasteners 30 are attached to the bracket 14 via the first set of fasteners 19. One or more of the first set of fasteners 19, are extended through the second set of fasteners 30, through the clip holes 144, and are threaded into the bracket 14. The bracket 14 may have reinforcement solid sections (not shown) in the mounting areas of the second set of fasteners 30 on the outer shell 50 where the first set of fasteners 19 are threaded therein.

Although the first set of fasteners 19 and the second set of fasteners 30 are shown as self-tapping screws and clips, respectively, other fasteners known in the art may be utilized. The fasteners may be of various types, styles, shapes, and sizes. The fasteners may be single unitary pieces or may be composed of multiple pieces. As another example, the second set of fasteners 30 may be replaced with the fasteners identical to or similar to the first set of fasteners 19. In such a replacement, the second set of fasteners is extended through the associated bracket, such as through the fastener holes 80, and into a vehicle structural member. This allows for a uniform common type of fastener to be utilized for bracket attachment and mounting.

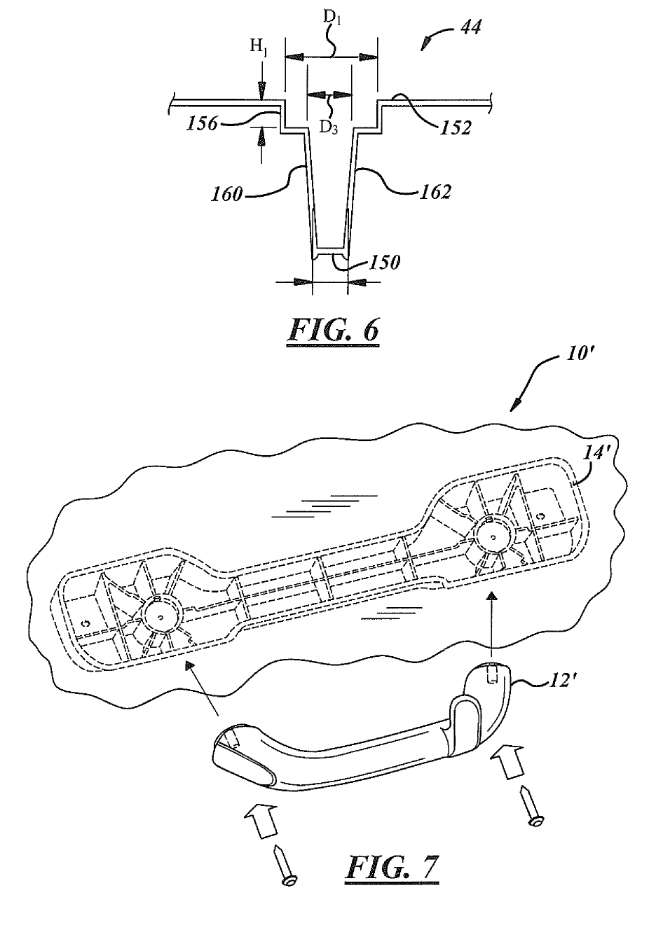

Referring now to FIGS. 1 and 6, in FIG. 6 a cross-sectional view of one of the outer fastener inserts 44 is shown. The fastener insert 44 has a front surface 150 and a back surface 152 that co-exists with the backside 46. The fastener insert 44 includes a two-stage inner cavity 154. The first stage 156 corresponds with the head 158 of one of the first set of fasteners 19 and has a first diameter D₁ that is slightly larger in size that the diameter D₂ of the head 158. The height H₁ of the first stage is approximately the same as the height H₂ of the fasteners 19. The second stage 160 has a tapered wall 162 that tapers in towards the front surface 150 to guide insertion of the fastener 19. The rear-most diameter D₃ of the second stage 160 is smaller than the diameter D₂.

Referring not to FIGS. 7-9, an exploded view of a grab handle assembly 10′ and front and back perspective views of a grab handle 12′ and bracket 14′ are shown in accordance with another embodiment of the present invention. The grab handle assembly 10′ is similar to the grab handle assembly 10, except the associated second set of fasteners (not shown) are attached to the backside 46′ of the bracket 14′. The grab handle assembly 10 is configured for sunroof applications and the like. The grab handle assembly 10 is configured and the bracket 14 is shaped such that the grab handle 12 hangs at an approximately 60° angle from horizontal. Whereas in comparison, the grab handle assembly 10′ is configured and the bracket 14′ is shaped such that the grab handle 12′ hangs in an approximately vertical position. The spacers 72′ of the grab handle assembly 10′ are also similar to the spacers 72, but are located on the backside 46′ and as such the bracket 14′ is formed accordingly.

The grab handle assembly 10′ includes cutouts 170 that are size biased towards one side 172 of the bracket 14′, such that a first cutout 174 is larger than a second cutout 176, which shifts the location of the center member 178 towards the side 172. In the first or larger cutout 174 a sunroof module, such as a sunroof rail or other sunroof module may be disposed between the main sections and between the bracket 14′ and a vehicle structural member, such as the vehicle structural member 28.

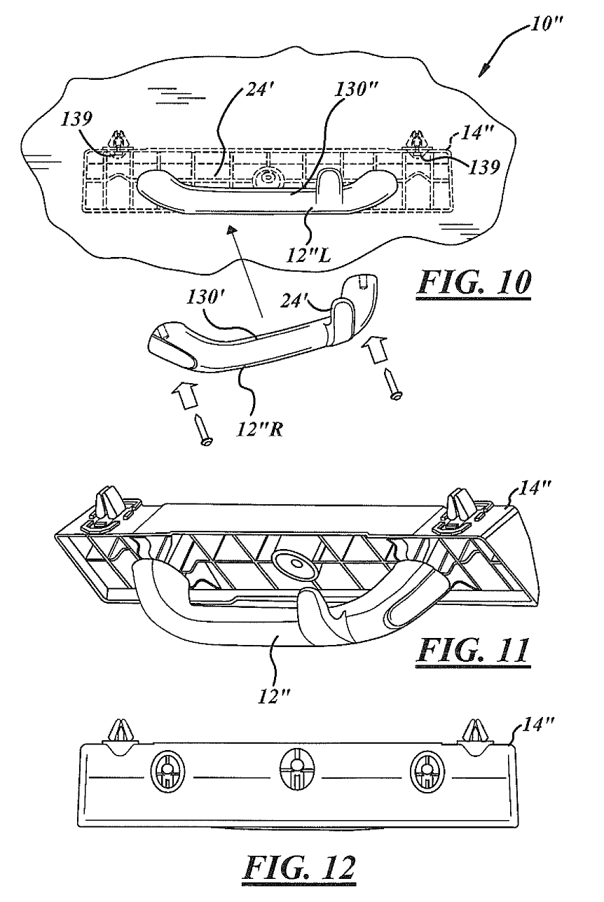

Referring now to FIGS. 10-12, exploded and perspective views of another grab handle assembly 10″ including perspective views of the grab handle 12″ and the bracket 14″ thereof are shown in accordance with an embodiment of the present invention. The primary difference between the grab handle assembly 10″ and the grab handle assemblies 10 and 10″, is that the grab handle assembly 10″ does not have module cutouts formed in the bracket 14″. FIG. 10 provides two example versions 12″L and 12″R of the grab handle 12″, which are configured for attachment to the bracket 14″, however, one of the grab handles may be considered a left handed grab handle and the other may be considered a right handed grab handle. The difference between the grab handles 12″L and 12″R is the integrally formed locations of the coat hooks 24′. The grab handles 12″L and 12″R are unhanded with respect to their gripping locations 130′ and 130″. Although the gripping locations 130′ and 130″ of the grab handles 12″L and 12″R may be shaped and formed to be used for left handed gripping or right handed gripping, they are uniformly shaped and dimensioned and thus are unhanded. Unhanded handles may be used for both left-handed and right-handed purposes and gripping. Of course, the above-described grab handles 12, 12′, and 12″L and 12″R may be of various shapes and sizes and have attached thereto or formed integrally therewith various different coat hooks.

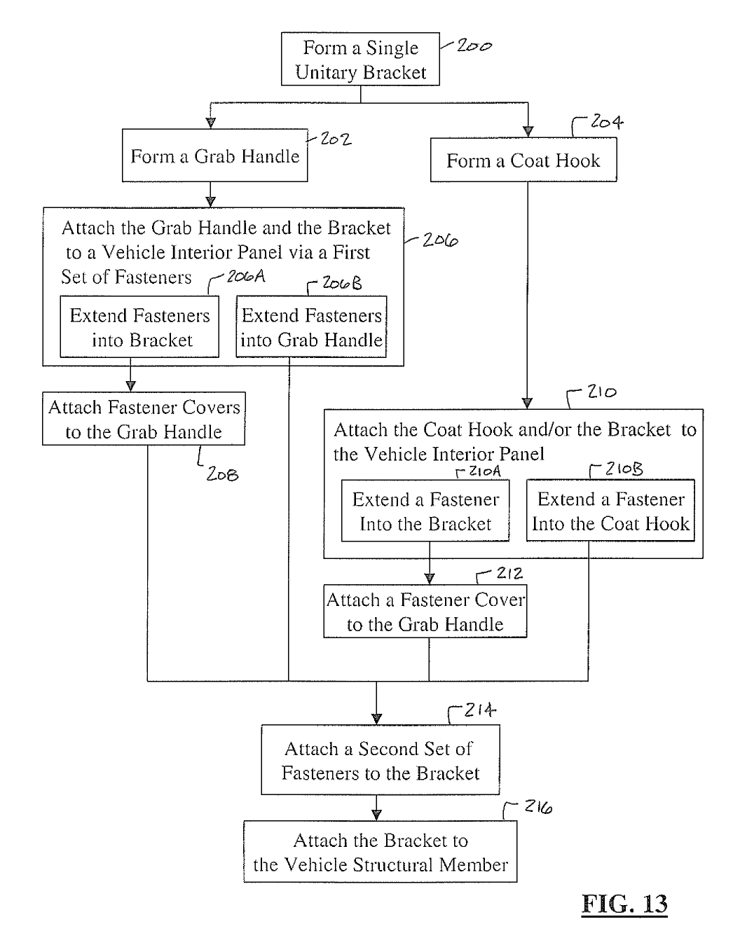

Referring now to FIG. 13, a logic flow diagram illustrating a method of manufacturing and assembling a grab handle for a vehicle.

In step 200, a single unitary bracket, such as one of the brackets 14, 14′, and 14″, is formed and configured for grab handle and/or coat hook attachment thereon. The bracket may also be formed using injection molding, blow molding, stereolithography, or other thermoplastic or plastic forming, tooling, or cutting techniques known in the art. The bracket may be formed to have an outer shape that matches an inner shape of a corresponding vehicle structural member. Although the bracket or any portion thereof may be formed as a solid unit, to minimize material use and overall weight of the bracket, the bracket is formed to have an outer shell and internal ribs as shown in FIGS. 1-2, 5, 7-8, and 10-11 and described above.

In step 202, a grab handle, such as one of the grab handles 12, 12′, and 12″, is formed and configured for vehicle occupant gripping. The grab handle may be formed using injection molding, blow molding, stereolithography, or other thermoplastic or plastic forming, tooling, or cutting techniques known in the art. The grab handle may be formed to include a coat hook, such as one of the coat hooks 24 and 24′, described above.

In step 204, a coat hook, such as the coat hook 22, may be formed and configured for attachment to the bracket. The coat hook may be formed in a similar fashion as the grab handle and the bracket.

In step 206, the grab handle and the bracket may be attached to a vehicle interior panel and to each other via a first set of fasteners, such as the fasteners 19. In step 206A, the fasteners are extended through the grab handle, through the interior panel, and into the bracket. In step 206B, the fasteners are extended through the bracket, through the interior panel, and into the grab handle. In step 208, when step 206A is performed, fastener covers, such as the fastener covers 42, are attached to the grab handle to hide the fasteners.

In step 210, as an alternative to steps 206-208, the coat hook of step 204 may be attached to a vehicle interior panel via a first set of fasteners, such as the fasteners 19. The coat hook may be attached to any of the fastener inserts of the bracket, depending upon the design of the bracket and the application. In step 210A, the fastener is extended through the coat hook, through the interior panel, and into the bracket. In step 210B, the fastener is extended through the bracket, through the interior panel, and into the coat hook. In step 212, a fastener cover, such as the fastener cover 60, is attached to the coat hook to hide the fastener.

In step 214, a second set of fasteners, such as the clips 30, are attached to the bracket. A third set of fasteners, such as the fasteners 139, is used to attach the second set of fasteners to the bracket. The third set of fasteners 139 is extended through the bracket and into the second set of fasteners or vice versa. Step 214 may be performed prior to steps 206 and 210.

In step 216, the bracket is attached to a vehicle structural member. The second set of fasteners or a portion thereof, such as the tabs 140, are inserted into assigned holes or slots within the vehicle structural member. Of course, other known attachment configurations may be utilized to attach the bracket to the vehicle structural member.

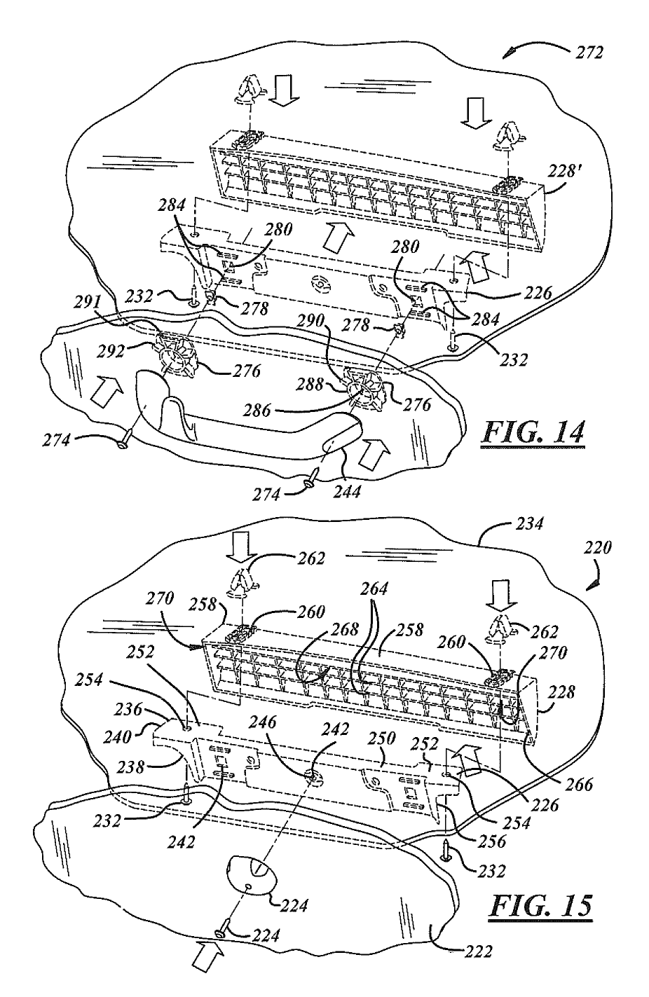

Referring now to FIG. 14, a perspective exploded view of an article hook assembly 220 in relation to a panel 222 and in accordance with another embodiment of the present invention is shown. The hook assembly 220 includes an article hook or coat hook 224, a support plate or bracket 226, and a shield housing 228. The hook 224 is attached to the bracket 226 via a hook fastener 230, which extends through the hook 224, through the substrate panel 222, and into the bracket 226. The bracket 226 is attached to the shield housing 228 via a first set of fasteners or bracket fasteners 232, which extend through the bracket 226, into or through the shield housing 228, and may extend into a vehicle structural member 234.

The bracket 226 is configured for both article hook and grab handle applications. The bracket 226 provides strength and rigidity to a hook assembly and a grab handle assembly and alone provides structural integrity to support and withstand forces exerted on an article hook and/or a grab handle. The side cross-section (not shown) of the bracket 226 is generally “L”-shaped. The bracket 226 has a body 236 that includes an attachment side 238 and a support side 240 that is perpendicular to the attachment side 238. The attachment side 238 includes attachment points 242 for the hook 224 and for a grab handle 244, such as that shown in FIG. 15. The hook attachment point 246, in the embodiment shown, is integrally formed as part of the bracket 226, may or may not be threaded, and allows for the screwing of the hook fastener 230 therein. The support side 240 includes a narrow center member 250 and two outer flanges 252. The outer flanges 252 are insertable into the shield housing 228. The bracket fasteners 232 extend through holes 254 in the flanges 252 and into the shield housing 228. Notches 256 are provided in the attachment side 238 to allow for ease in insertion of the bracket fasteners 232.

The bracket 226 may be formed of various rigid materials, such as steel, aluminum, titanium, or other rigid material known in the art. The bracket 226 is described in further detail below with respect to FIG. 15. The bracket 226 may have various thicknesses, weights, sizes, and shapes, depending upon the application. The bracket 226 may also be formed of various strength materials.

The shield housing 228 is also configured for both article hook and grab handle utilization. Although the shield housing 228, in the sample embodiments shown and described with respect to FIGS. 14-16, in appearance is similar to the bracket 14″, the shield housing 228 is substantially different than the bracket 14″. Unlike the bracket 14″, which provides full support for an article hook or grab handle, the shield housing 228 is used primarily to provide air bag protection and to assure that the bracket 226 is rigidly attached to a vehicle structure. The shield housing 228, like the bracket 14″, includes curved or rounded outer edges 258 to prevent damage to an air bag that is deployed and comes in contact with the shield housing 228. The shield housing 228 covers the bracket 226 and prevents an air bag from coming in contact with the bracket 226 and thus any edges thereof. Unlike the bracket 14″, the shield housing 228 is indirectly attached to the article hook 224 or the grab handle 244.

The shield housing 228, like the bracket 14″, includes mounting pads 260 that assure proper separation and mounting of the assembly 220 to provide a rigid attachment thereof to the vehicle structure 234. The mounting pads 260 allow for the attachment of a second set of fasteners 262, which are similar to the fasteners 30. The bracket fasteners 232 thread into the second set of fasteners 262.

Another distinction between the bracket 14″ and the shield housing 228 is that the bracket 14″ is generally formed of a hardened material, such as a hardened plastic, whereas, the shield housing 228 is formed of a non-hardened plastic or the like. The shield housing 228 may, for example, be formed of thermoplastic olefin (TPO) or other lightweight non-hardened plastic or similar material(s).

The shield housing 228 is configured for insertion of at least a portion of the bracket 226 therein. The shield housing 228 includes internal ribs 264 that are incorporated to prevent the shield housing 228 from warping. The internal ribs 264 have an associated layout within the shell 266 of the shield housing 228 to allow for insertion of the support side 240. The shield housing 228 includes an upper shallow center pocket 268 and two upper deep outer pockets 270. The center member 250 is inserted within the shallow pocket 268. The outer flanges 252 are inserted into the deep pockets 270.

Of course, one may envision an application where the formation of a shield housing having similar materials, rigidity and strength as the bracket 14″ is desired. As such, the embodiments of FIGS. 14-16 may be easily modified to satisfy that desire.

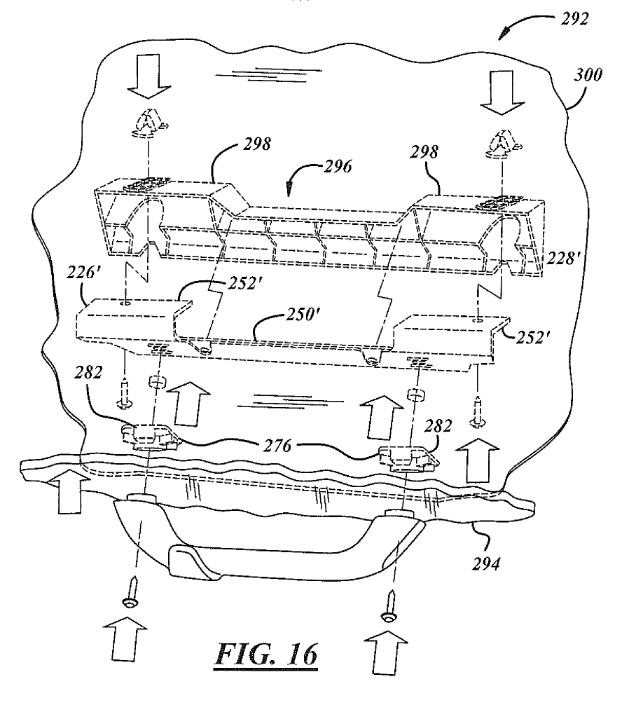

Referring now to FIG. 15, a perspective exploded view of a grab handle assembly 272 in relation to the panel 222 utilizing similar components as that of the article hook assembly 220 of FIG. 14 and is in accordance with another embodiment of the present invention is shown. The grab handle assembly 272 includes the grab handle 244, which is similar to one of the grab handles 12, 12′, and 12″, and the bracket 226 and the shield housing 228′. The grab handle 244 is attached to the bracket 226 via a third set of fasteners or grab handle fasteners 274, which extend through the grab handle 244, through the spacers 276, and into fastener receivers 278. The fasteners receivers 278 may be in the form of palnuts or other type of receiving component for attaching a fastener to a bracket. The fasteners receivers 278 are inserted into openings 280 on the attachment side 238. The spacers 276 include integrally formed clips 282, which are best shown in FIG. 16, that are inserted into slots 284 proximate the openings 280. The grab handle fasteners 274 thread into the fasteners receivers 278 and rigidly hold the grab handle 244 to the bracket 226. The fasteners receivers 278 may be formed of various metallic materials or other suitable materials for rigidly holding the grab handle fasteners 274.

The spacers 276 are configured similar to the grab handle attachment areas 113, described above. The spacers 276 have attachment points 286, cylindrical members 288, and recessed middle sections 290, which may be keyed and thus have notches (not shown), similar to notches 118. The spacers 276 also include backing plates 291 on which the members 288 are formed. Spacer ribs 292 extend outward from the members 288 on the backing plates 291. The spacers 276 may be formed of the same or similar materials as that of the above-described grab handles 12, 12′, 12″, and 12′″.

Referring now to FIG. 16, a perspective exploded view of another grab handle assembly 292 in relation to a panel 294 that is configured for sunroof applications and is in accordance with another embodiment of the present invention is shown. The grab handle assembly 292 is similar to the grab handle assembly 272, however it is modified for sunroof applications. The grab handle assembly 292 includes a bracket 226′ and a shield housing 228′ that are modified from the bracket 226 and shield housing 228 to accommodate for a sunroof module (not shown). The shield housing 228′ has a top center cutout 296 that is integrally formed between two main outer sections 298. In the top center cutout 296 a vehicle module may be disposed between the main sections 298 and between the shield housing 228′ and the vehicle structural member 300. Of course, other modules, cables, channels, structures, or the like may be located within or extend through the cutout 296.

The bracket 226′ also includes an attachment side 238 and a support side 240. The support side 240 has a center member 250′ that extends between two outer flanges 252′. The outer flanges 252′ are similar to the outer flanges 252 however, they have increased overall length and size to compensate for reduced size of the center member 250′. Also, the pockets 268′ and 270′ of the shield housing 228′ are similar to the pockets 268 and 270, but are configured to receive the center member 250′ and the flanges 252′.

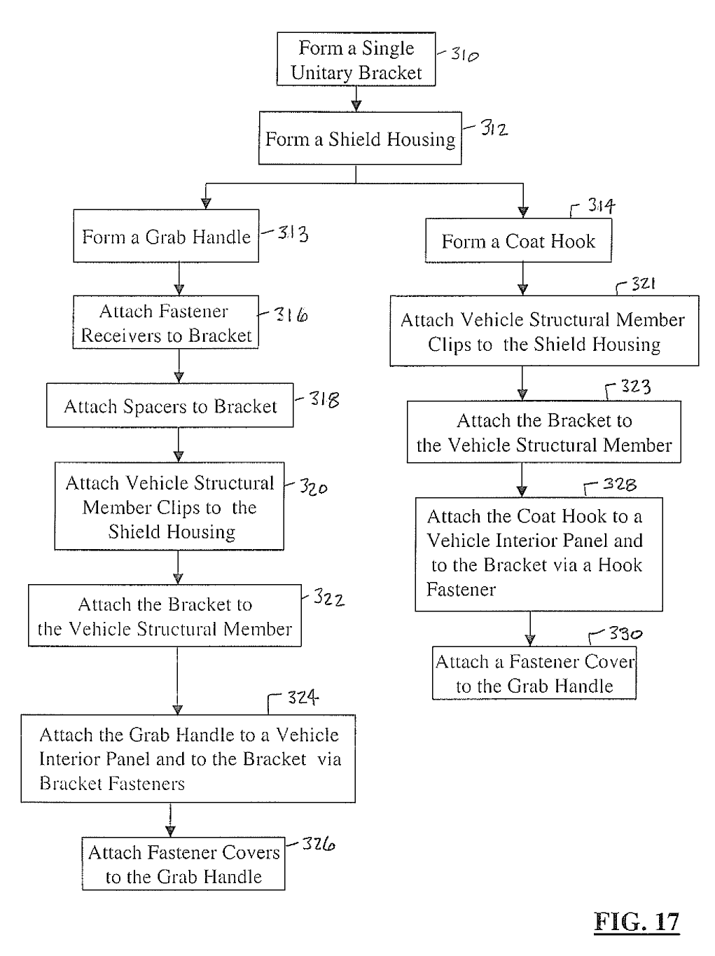

Referring now to FIG. 17, a logic flow diagram illustrating a method of manufacturing and assembling a grab handle assembly in accordance with another embodiment of the present invention is shown. Although the following steps are primarily described with respect to the embodiments of FIGS. 14-16, they may be modified for other embodiments of the present invention.

In step 310, a bracket, such as one of the brackets 226 or 226′, is formed and configured for the attachment thereon of an article hook, a grab handle, spacers, and fastener receivers, such as the article hook 224, the grab handle 244, the spacers 276, and the fasteners receivers 278. The bracket may be formed using various techniques known in the art.

In step 312, a shield housing, such as one of the shield housings 228 or 228′, is formed and configured for bracket insertion and attachment therein. The shield housing may also be formed using injection molding, blow molding, stereolithography, or other thermoplastic or plastic forming, tooling, or cutting techniques known in the art. Although the shield housing or any portion thereof may be formed as a solid unit, to minimize material use and overall weight of the shield housing, the shield housing is formed to have an outer shell and internal ribs as shown in FIGS. 14-16.

In step 313, a grab handle, such as one of the grab handles 244, is formed and configured as described in step 200.

In step 314, a coat hook, such as the coat hook 22, may be formed and configured for attachment to the bracket. The coat hook may be formed in a similar fashion as the grab handle and the bracket.

In step 316, the fasteners receivers are attached to the bracket. In step 318, the spacers are attached to the bracket over the fasteners receivers 278.

In steps 320 and 321, the bracket and clips, such as the clips 262, are attached to the shield housing. The bracket is inserted into the shield housing. Fasteners, such as the second set of fasteners 232, are extended through the bracket through the shield housing and threaded into the clips. In steps 322 and 323, the clips are inserted into and attached to a vehicle structure.

In step 324, the grab handle may be attached to a vehicle interior panel and to the bracket via grab handle fasteners, such as the fasteners 274. The fasteners are extended through the grab handle, through the interior panel, through the spacers, and into the fasteners receivers. In step 326, fastener covers, such as the fastener covers 42, are attached to the grab handle to hide the grab handle fasteners. Steps 324 and 326 may be performed prior to step 322.

In step 328, as an alternative to steps 324-326, the coat hook of step 324 may be attached to a vehicle interior panel via a hook fastener, such as the fastener 230. The coat hook may be attached to the center attachment point on the bracket, depending upon the design of the bracket and the application. The fastener is extended through the coat hook, through the interior panel, and into the bracket. In step 330, a fastener cover, such as the fastener cover 60, is attached to the coat hook to hide the hook fastener. Steps 328 and 330 may be performed prior to step 323.

The above-described steps in FIGS. 13 and 17 are meant to be illustrative examples; the steps may be performed sequentially, synchronously, simultaneously, or in a different order depending upon the application. Also, layers may be formed and cured prior to application to other layers. Also layers, such as thermoplastic layers may be molded and cured, and then remolded. In addition, the above-stated vehicle structural covers may be formed using textile and/or paper making processes known in the art.

Note also that throughout the above description that terms such as “first”, “second”, and “third” are utilized in referring to various components. These designations are arbitrary and may be altered. For example, a first set of fasteners, may also be referred to a second set of fasteners or a third set of fasteners depending upon the point of view and the context.

The present invention provides a high strength and durable grab handle assembly. The material utilized and the design configuration of the bracket associated with the grab handle assembly provides a grab handle that is capable of withstanding pull forces of greater than 200 lbs.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A grab handle assembly comprising:
a grab handle configured for vehicle occupant gripping and comprising a first plurality of attachment points;
only a single bracket comprising a second plurality of attachment points, said second plurality of attachment points configured to mechanically couple to said first plurality of attachment points;
a first plurality of fasteners configured to attach said bracket to said grab handle; and
a second plurality of fasteners configured to attach said bracket to a vehicle structural member.

2. An assembly as in claim 1 wherein said grab handle is formed from at least one material selected from polypropolyne, polypropylene, acrylonitrile butadiene styrene (ABS), acetal, polycarbonate, polycarbonate-ABS, fiberglass, maleic anhydride-styrene polymer, styrene-butadiene polymer, and fiber reinforced thermoplastic.

3. An assembly as in claim 1 wherein said bracket is formed from at least one material selected from polypropolyne, polypropylene, acrylonitrile butadiene styrene (ABS), acetal, polycarbonate, polycarbonate-ABS, magnesium silicate hydroxide (Talc), fiberglass, maleic anhydride-styrene polymer, styrene-butadiene polymer, and fiber reinforced thermoplastic.

4. An assembly as in claim 1 wherein said bracket is formed of approximately 30% glass filed polypropolyne.

5. An assembly as in claim 1 wherein said bracket comprises:
an outer shell; and
a plurality of ribs integrally formed with and coupled within said outer shell.

6. An assembly as in claim 5 wherein plurality of ribs comprise energy displacing ribs.

7. An assembly as in claim 1 wherein said second plurality of attachment points comprises at least one article hook attachment point.

8. An assembly as in claim 1 further comprising an article hook attached to said bracket.

9. An assembly as in claim 8 wherein said article hook is directly coupled to said grab handle.

10. An assembly as in claim 8 wherein said article hook attaches directly to at least one of said second plurality of attachment points via a coat hook fastener.

11. An assembly as in claim 10 wherein said grab handle, said bracket, and said article hook are configured such that at any instance in time only one of said grab handle or said article hook is attached to said bracket.

12. An assembly as in claim 1 wherein said bracket is formed and shaped to be airbag friendly.

13. An assembly as in claim 1 wherein said second plurality of fasteners are multi-directional meaning they may be attached to said bracket in more than one direction.

14. An assembly as in claim 1 wherein said second plurality of attachment points are keyed to align with said first plurality of attachment points.

15. An assembly as in claim 1 wherein said bracket comprises a module cutout.

16. An assembly as in claim 1 wherein said first plurality of fasteners comprises:
at least one coat hook fastener; and
at least one grab handle fastener that is synonymous with said at least one coat hook fastener.

17. An assembly as in claim 1 wherein said first plurality of attachment points are configured to extend through a vehicle panel in coupling said second plurality of attachment points to said first plurality of attachment points

18. A system as in claim 17 wherein said interior panel is a headliner and said second plurality of fasteners are configured to clip vertically into a body-in-white roof section of a vehicle.

19. A grab handle/article hook assembly module for a vehicle comprising:
only a single body comprising:
an attachment side comprising a plurality of attachment points configured for attachment thereon of either an article hook for article handing or a grab handle configured for vehicle occupant gripping; and
a support side configured for attachment to a vehicle structural member;
said body having structural integrity to alone support a grab handle.

20. A module as in claim 19 wherein said body comprises a plurality of support ribs.

21. A module as in claim 19 wherein said support side comprises at least one flange for insertion into and attachment to a shield housing.

22. A method of manufacturing and assembling a grab handle for a vehicle comprising:
fastening a single unitary bracket to a grab handle that is configured for vehicle occupant gripping comprising extending a first plurality of fasteners through said bracket, through an interior panel, and into said grab handle;
attaching a second plurality of fasteners to said bracket; and
attaching said bracket to a vehicle structural member via said second plurality of fasteners.

23. A method as in claim 22 comprising:
forming said grab handle to be configured for vehicle occupant gripping; and
forming said single unitary bracket of a thermoplastic material and configured for attachment thereto of said grab handle or a coat hook.

24. A grab handle assembly comprising:
a grab handle configured for vehicle occupant gripping and comprising a first plurality of attachment points;
only a single bracket comprising a second plurality of attachment points, said second plurality of attachment points configured to mechanically couple to said first plurality of attachment points;
a first plurality of fasteners configured to attach said bracket to said grab handle;
a shield housing covering at least a portion of said bracket;
a second plurality of fasteners coupling said bracket to said shield housing; and
a third plurality of fasteners coupling said shield housing to a vehicle structural member.

25. A grab handle assembly as in claim 24 further comprising a plurality of palnuts coupled to said bracket, said first plurality of fasteners coupling said plurality of fasteners receivers.

26. A grab handle assembly as in claim 24 further comprising a plurality of spacers coupled to said bracket, said spacers separating a vehicle substrate from said grab handle.

27. A grab handle assembly as in claim 24 wherein said shield housing comprises a module cutout.

28. A grab handle assembly as in claim 24 wherein said second plurality of attachment points comprises at least one article hook attachment point.

29. A grab handle assembly as in claim 24 further comprising an article hook attached to said bracket.

30. A method of manufacturing and assembling a grab handle for a vehicle comprising:
attaching a support bracket to a shield housing via a first set of fasteners comprising extending said first set of fasteners through said support bracket, through said shield housing and into a second set of fasteners;
attaching said shield housing to a vehicle structural member via said second set of fasteners; and
fastening a grab handle, that is configured for vehicle occupant gripping, to said support bracket comprising extending a third set of fasteners through said grab handle, through an interior panel, and into said support bracket.

31. A method as in claim 30 further comprising coupling at least one spacer between said support bracket and said interior panel.

32. A method as in claim 30 wherein fastening a grab handle to said support bracket comprises:
coupling a plurality of fastener receivers to said bracket; and
extending said third set of fasteners through said grab handle, through said interior panel, and into said plurality of fastener receivers.

33. An article hook assembly comprising:
an article hook configured for article hanging and comprising at least one hook attachment point;
only a single bracket comprising a plurality of bracket attachment points configured to mechanically couple to said hook attachment point;
a hook fastener configured to extend through a substrate panel and attach said article hook to said bracket; and
a plurality of bracket fasteners configured to attach said bracket to a vehicle structural member.

34. An assembly as in claim 33 further comprising a shield housing coupled to and covering at least a portion of said bracket.

35. An assembly as in claim 33 wherein said plurality of bracket attachment points are configured for grab hand attachment thereon.
